(19) United States
(12) Patent Application Publication
(10) Pub. No.: US 2006/0239316 A1
(43) Pub. Date: Oct. 26, 2006

(54) Apparatus for controlling temperature of optical module using uncooled laser diode

(75) Inventors: Dae Jin Kim, Gyeonggi-do (KR); Bo Young Choi, Gwangju (KR); Kwang Jin Yang, Gyeonggi-do (KR); Moon Soo Park, Gwangju (KR)

Correspondence Address: JORDAN AND HAMBURG LLP, 122 EAST 42ND STREET, SUITE 4000, NEW YORK, NY, 10168, US

(73) Assignee: Opto Electronics Solutions Co., Ltd., Gwangju (KR)

(21) Appl. No.: 11/136,944

(22) Filed: May 24, 2005

(30) Foreign Application Priority Data
Apr. 25, 2005 (KR) 2005-0034092

(51) Int. Cl. H01S 3/04; H01S 3/00

(52) U.S. Cl. 372/34; 372/36; 372/38.01

(57) ABSTRACT

The present invention relates to an apparatus for controlling temperature of an optical module using an uncooled laser diode. A first setup unit for establishing low-temperature setup voltage and a second setup unit for establishing high-temperature setup voltage determine first and second threshold voltages suitable for low-temperature and high-temperature setup voltages, respectively. First and second comparators compare the low-temperature and high-temperature setup voltages with sensor voltage received from a sensor voltage entry unit, respectively. The output signals of the comparators are applied to a logic circuit, such that the logic circuit generates on/off signals according to the result of the comparison. The logic circuit generates a high-level signal only when the sensor voltage escaped from a predetermined voltage range, and thus operates the temperature control circuit. Therefore, the TEC and the heater contained in the TEC/heater mounting member are operated to generate heat, such that the uncooled laser diode can be heated or cooled at only predetermined temperature. As a result, the uncooled laser diode can be heated or cooled at only predetermined temperature, controls temperature of the optical module at a low power level, resulting in reduction of power consumption.

### BACKGROUND OF THE INVENTION

1. Field of the Invention

The present invention relates to an apparatus for controlling temperature of an optical module using an uncooled laser diode, and more particularly to an apparatus for controlling temperature of an optical module at a low power level using an uncooled laser diode, such that it can greatly reduce power consumption.

2. Description of the Related Art

Typically, application of a conventional optical module, such as an optical transmitter/receiver module, is considerably limited due to variation in wavelength according to temperature of an uncooled laser diode.

In other words, the uncooled laser diode for use in a Coarse Wavelength Division Multiplex (CWDM) optical module shows wavelength variation of 0.1 nm per degree Celsius (i.e., temperature of 1° C.). In order to prevent the occurrence of interchannel interference, the above-mentioned uncooled laser diode allows predetermined variation of X-6.5 nm/X+6.5 nm on the basis of a reference wavelength of Xnm.

Therefore, the temperature variation allowed within the above-mentioned reference is limited to about 75° C., such that a variety of problems are unexpectedly generated when the uncooled laser diode is applied to a wider temperature range.

### SUMMARY OF THE INVETION

Therefore, the present invention has been made in view of the above problems, and it is an object of the invention to provide an apparatus for controlling temperature of an optical module, which operates a temperature control circuit at only predetermined temperature using an uncooled laser diode, such that it greatly reduces power consumption.

It is another object of the present invention to provide an apparatus for controlling temperature of an optical module, which overcomes a limited temperature range of a conventional optical module, such that it maintains/controls a wavelength and unique characteristics of the conventional optical module within a wider temperature range.

In accordance with one aspect of the present invention, the above and other objects can be accomplished by the provision of an apparatus for controlling temperature of an optical module using an uncooled laser diode, comprising: a first setup unit for establishing low-temperature setup voltage to perform a heating operation; a sensor voltage entry unit for entering sensor voltage; a second setup unit for establishing high-temperature setup voltage to perform a cooling operation; a first comparator connected to the first setup unit, for comparing the low-temperature setup voltage determined by the first setup unit with the sensor voltage received from the sensor voltage entry unit; a second comparator connected to the second setup unit, for comparing the high-temperature setup voltage determined by the second setup unit with the sensor voltage received from the sensor voltage entry unit; a logic circuit connected to the first setup unit and the second setup unit, for generating on/off signals according to output signals of the first and second comparators; a temperature control circuit connected to the logic circuit, for controlling the logic circuit to generate a high-level signal only when the sensor voltage escapes from a predetermined voltage, such that it is operated by the high-level signal generated from the logic circuit; and a TEC(Temperature Electric Cooler)/heater mounting member for operating a TEC and a heater when the temperature control circuit is operated, generating heat, heating or cooling the uncooled laser diode only at predetermined temperature, including a TOSA(Transmitter Optical Sub-Assembly)/TEC mounting member and a TOSA/heater mounting member, and selectively using the TOSA/TEC mounting member or the TOSA/heater mounting member as necessary.

Preferably, the TOSAITEC mounting member includes: a TOSA for including the uncooled laser diode and a PCB (Printed Circuit Board) connection terminal connected to a PCB; a first temperature sensing resistor acting as a temperature sensor for detecting temperature; a TEC mounted to the outside of an upper part of the TOSA, heating the uncooled laser diode at low temperature, cooling the uncooled laser diode at high temperature, and preventing characteristics of the uncooled laser diode from being changed; and a TOSA/TEC fixing unit for fixing the TOSA and the TEC at predetermined locations.

Preferably, the TOSA/TEC fixing unit includes: a TOSA insertion unit in which the TOSA is inserted; a temperature sensor resistor insertion unit in which the first temperature sensor resistor is inserted; and a TEC insertion unit in which the TEC is inserted.

Preferably, the TOSA is fixed to the TOSA insertion unit centrally formed in a lateral side of the TOSA/TEC fixing unit by epoxy, the first temperature sensor resistor is fixed to the temperature sensor resistor insertion unit located at an edge of the lateral side of the TOSA/TEC fixing unit by epoxy, and the TEC is fixed to the TEC insertion unit included in an upper part of the TOSA/TEC fixing unit by epoxy.

Preferably, the TOSA/heater mounting member includes: a TOSA for including an uncooled laser diode and a PCB connection terminal connected to a PCB; a heater mounted to the PCB connection terminal of the TOSA, heating the uncooled laser diode at low temperature, and preventing characteristics of the uncooled laser diode from being changed; a second temperature sensing resistor acting as a temperature sensor for detecting temperature; and a TOSA/heater fixing unit for fixing the TOSA including the heater.

Preferably, the TOSA/heater fixing unit includes: a TOSA insertion unit in which the TOSA is inserted; and a temperature sensor resistor insertion unit in which the second temperature sensor resistor is inserted.

Preferably, the heater is fixed to the PCB connection terminal of the TOSA by epoxy,

the TOSA is fixed to the TOSA insertion unit included in both sides of the TOSA/heater fixing unit by epoxy, and the second temperature sensor resistor is fixed to the temperature sensor resistor insertion unit located at an edge of the lateral side of the TOSA/TEC fixing unit by epoxy.

Preferably, the first temperature sensor resistor can be attached to all locations of the TOSA/TEC fixing unit, and the second temperature sensor resistor can be attached to all locations of the heater or the TOSA/heater fixing unit as necessary.

### BRIEF DESCRIPTION OF THE DRAWINGS

The above objects, and other features and advantages of the present invention will become more apparent after reading the following detailed description when taken in conjunction with the drawings, in which:

FIG. 1 is a block diagram illustrating an apparatus for controlling temperature of an optical module using an uncooled laser diode according to the present invention;

FIG. 2 is an exploded perspective view illustrating a TOSA Transmitter Optical Sub-Assembly)/TEC (Temperature Electric Cooler) mounting member for installing both a TOSA having an uncooled laser diode and a TEC therein according to the present invention;

FIG. 3 is an exploded perspective view illustrating a TOSA/heater mounting member for installing both a TOSA including an uncooled laser diode and a heater therein according to the present invention;

FIG. 4 shows a completely assembled state of the TOSA/TEC mounting member in which both a TOSA including an uncooled laser diode and a TEC are coupled according to the present invention; and

FIG. 5 shows a completely assembled state of the TOSA/heater mounting member in which both a TOSA including an uncooled laser diode and a heater are coupled according to the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

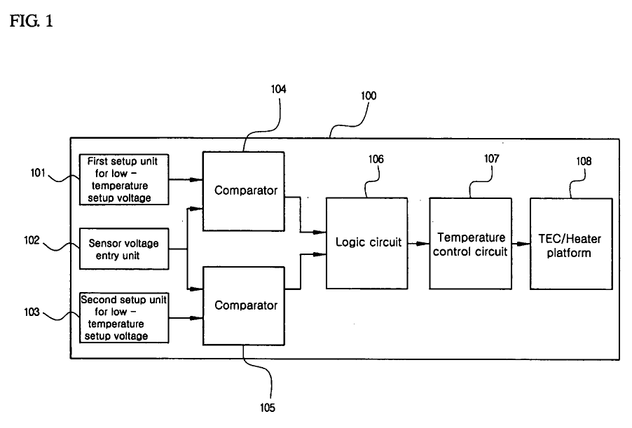

FIG. 1 is a block diagram illustrating an apparatus for controlling temperature of an optical module (e.g., an optical transmitter/receiver module) using an uncooled laser diode according to the present invention.

As shown in FIG. 1, an apparatus 100 for controlling temperature of an optical module (hereinafter referred to as an optical module temperature controller 100) includes a first setup unit 101 for establishing low-temperature setup voltage, a sensor voltage entry unit 102, a second setup unit 103 for establishing high-temperature setup voltage, comparators 104 and 105, a logic circuit 106, a temperature control circuit 107, and a TEC/heater mounting member 108.

In order to perform heating and cooling operations using the temperature control circuit 107, the first setup unit 101 for establishing low-temperature setup voltage determines first threshold voltage suitable for low-temperature setup voltage, and the second setup unit 103 for establishing high-temperature setup voltage determines second threshold voltage suitable for high-temperature setup voltage.

The low-temperature setup voltage determined by the first setup unit 101 is applied to the comparator 104 connected to the first setup unit 101. The comparator 104 compares the low-temperature setup voltage determined by the first setup unit 101 with sensor voltage received from the sensor voltage entry unit 102.

The high-temperature setup voltage determined by the second setup unit 103 is applied to the comparator 105 connected to the second setup unit 103. The comparator 105 compares the high-temperature setup voltage determined by the second setup unit 103 with sensor voltage received from the sensor voltage entry unit 102.

The output signals of the comparators 104 and 105 are applied to the logic circuit 106 connected to the first and second setup units 101 and 103. The logic circuit 106 outputs on/off signals according to the output signals of the comparators 104 and 105.

In the meantime, if the sensor voltage generated from the sensor voltage entry unit 102 is equal to or higher than a predetermined setup voltage, the logic circuit 106 outputs a high-level signal, such that the high-level signal operates the temperature control circuit (also called a TEC drive) 107 connected to the logic circuit 106.

If the temperature control circuit 107 is operated by the above-mentioned results, a TEC and a heater contained in the TEC/heater mounting member 108 are operated, resulting in the occurrence of heat. Therefore, the uncooled laser diode can be heated or cooled only at predetermined temperature. In other words, the uncooled laser diode can be heated or cooled within a necessary temperature range.

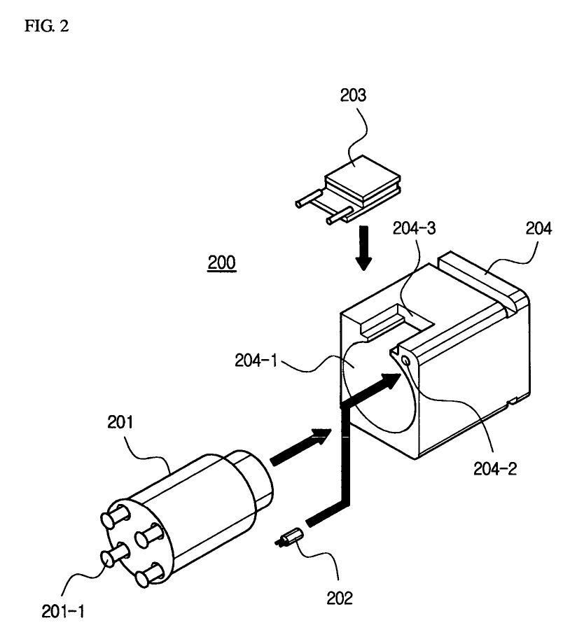

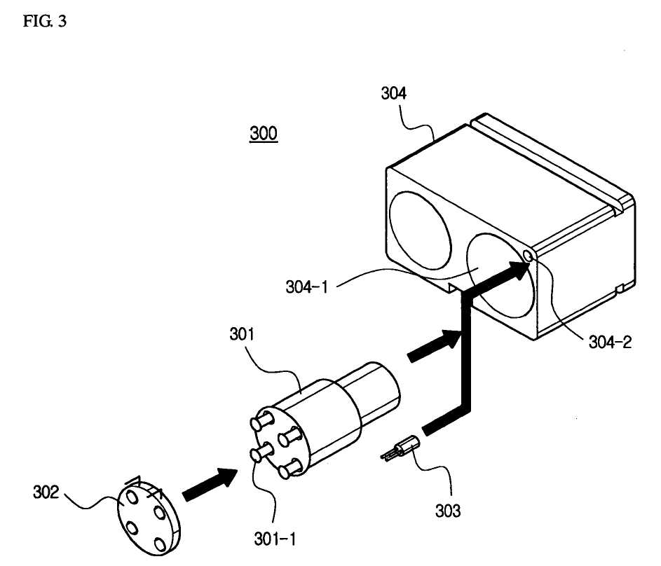

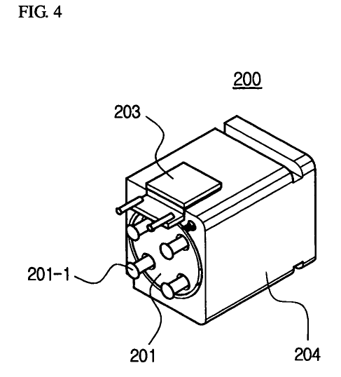

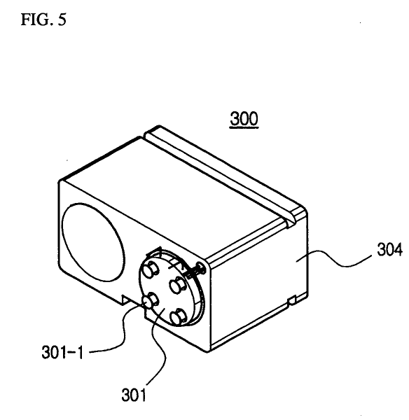

The TOSA/TEC mounting member 200 shown in FIGS. 2 and 4 and the TOSA/heater mounting member 300 shown in FIGS. 3 and 5 are separated from each other. The TOSA/TEC mounting member 200 or the TOSA/heater mounting member 300 is properly installed in the TEC/heater mounting member 108 as necessary, such that the TEC/heater mounting member 108 uses the TOSA/TEC mounting member 200 or the TOSA/heater mounting member 300.

The TOSA/TEC mounting member 200 and the TOSA/heater mounting member 300 will hereinafter be described with reference to FIGS. 2-5.

FIG. 2 is an exploded perspective view illustrating a TOSA/TEC mounting member 200 in which a TOSA having an uncooled laser diode and a TEC are installed according to the present invention. FIG. 4 shows a completely assembled state of the TOSA/TEC mounting member 200 in which both a TOSA 201 including an uncooled laser diode and a TEC 203 are coupled according to the present invention.

As shown in FIG. 2, the TOSA/TEC mounting member 200 includes a TOSA 201 for including an uncooled laser diode (not shown) and a PCB connection terminal 201-1 connected to a PCB (not shown); a first temperature sensing resistor 202 acting as a temperature sensor for detecting temperature; a TEC 203 mounted to the outside of an upper part of the TOSA 201, heating the uncooled laser diode at low temperature, cooling the uncooled laser diode at high temperature, and preventing characteristics of the uncooled laser diode from being changed; and a TOSA/TEC fixing unit 204 for fixing the TOSA 201 and the TEC 203 at predetermined locations.

The TOSA/TEC fixing unit 204 includes a TOSA insertion unit 204-1 in which the TOSA 201 is inserted; a first temperature sensor resistor insertion unit 204-2 in which a first temperature sensor resistor 202 is inserted; and a TEC insertion unit 204-3 in which the TEC 203 is inserted.

The TOSA 201 is fixed to the TOSA insertion unit 204-1 centrally formed in the lateral side of the TOSA/TEC fixing unit 204 by epoxy. In this manner, the first temperature sensor resistor 202 is also fixed to the first temperature sensor resistor insertion unit 204-2 located at an edge of the lateral side of the TOSA/TEC fixing unit 204 by epoxy.

The TEC 203 is fixed to the TEC insertion unit 204-3 included in an upper part of the TOSA/TEC fixing unit 204 by epoxy.

FIG. 3 is an exploded perspective view illustrating the TOSA/heater mounting member 300 for installing both a TOSA including an uncooled laser diode and a heater therein according to the present invention. FIG. 5 shows a completely assembled state of the TOSA/heater mounting member 300 in which a TOSA 301 including an uncooled laser diode and a heater 302 are coupled.

As shown in FIG. 3, the TOSA/heater mounting member 300 includes a TOSA 301 for including an uncooled laser diode (not shown) and a PCB connection terminal 301-1 connected to a PCB (not shown); a heater 302 mounted to the PCB connection terminal 301-1 of the TOSA 301, heating the uncooled laser diode at low temperature, and preventing characteristics of the uncooled laser diode from being changed; a second temperature sensing resistor 303 acting as a temperature sensor for detecting temperature; and a TOSA/heater fixing unit 304 for fixing the TOSA 301 including the heater 302.

The TOSA/heater fixing unit 304 includes a TOSA insertion unit 304-1 in which the TOSA 301 is inserted; and a second temperature sensor resistor insertion unit 304-2 in which a second temperature sensor resistor 303 is inserted.

The heater 302 is connected to the PCB connection terminal 301-1 of the TOSA 301, such that it is fixed to the PCB connection terminal 301-1 of the TOSA 301. The TOSA 301 is fixed to the TOSA insertion unit 304-1 included in both sides of the TOSA/heater fixing unit 304 by epoxy. In this manner, the second temperature sensor resistor 303 is also fixed to the second temperature sensor resistor insertion unit 304-2 located at an edge of the lateral side of the TOSA/heater fixing unit 304 by epoxy.

Although the first and second temperature sensor resistors 202 and 303 are located as shown in FIGS. 2 and 3, the locations of the first and second temperature sensor resistors 202 and 303 are not limited to specific locations of the TOSA/TEC fixing unit 204 and the TOSA/heater fixing unit 304, such that the first temperature sensor resistor 202 may be attached to all locations of the TOSA/TEC fixing unit 204, and the second temperature sensor resistor 303 may be attached to all locations of the heater 302 or the TOSA/heater fixing unit 304 as necessary, resulting in the same operation and effect.

As apparent from the above description, the present invention controls temperature of an optical module at a low power level using an uncooled laser diode, resulting in reduction of power consumption.

Also, the present invention overcomes a limited temperature range of a conventional optical module, such that it maintains/controls a wavelength and unique characteristics of the conventional optical module within a wider temperature range.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for controlling temperature of an optical module using an uncooled laser diode, comprising:
a first setup unit for establishing low-temperature setup voltage to perform a heating operation;
a sensor voltage entry unit for entering sensor voltage;
a second setup unit for establishing high-temperature setup voltage to perform a cooling operation;
a first comparator connected to the first setup unit, for comparing the low-temperature setup voltage determined by the first setup unit with the sensor voltage received from the sensor voltage entry unit;
a second comparator connected to the second setup unit, for comparing the high-temperature setup voltage determined by the second setup unit with the sensor voltage received from the sensor voltage entry unit;
a logic circuit connected to the first setup unit and the second setup unit, for generating on/off signals according to output signals of the first and second comparators;
a temperature control circuit connected to the logic circuit, for controlling the logic circuit to generate a high-level signal only when the sensor voltage escapes from a predetermined voltage, such that it is operated by the high-level signal generated from the logic circuit; and
a TEC(Temperature Electric Cooler)/heater mounting member for operating a TEC and a heater when the temperature control circuit is operated, generating heat, heating or cooling the uncooled laser diode only at predetermined temperature, including a TOSA(Transmitter Optical Sub-Assembly)/TEC mounting member and a TOSA/heater mounting member, and selectively using the TOSA/TEC mounting member or the TOSA/heater mounting member as necessary.

2. The apparatus according to claim 1, wherein the TOSA/TEC mounting member includes:
a TOSA for including the uncooled laser diode and a PCB (Printed Circuit Board) connection terminal connected to a PCB;
a first temperature sensing resistor acting as a temperature sensor for detecting temperature;
a TEC mounted to the outside of an upper part of the TOSA, heating the uncooled laser diode at low temperature, cooling the uncooled laser diode at high temperature, and preventing characteristics of the uncooled laser diode from being changed; and
a TOSA/TEC fixing unit for fixing the TOSA and the TEC at predetermined locations.

3. The apparatus according to claim 2, wherein the TOSA/TEC fixing unit includes:
a TOSA insertion unit in which the TOSA is inserted;
a first temperature sensor resistor insertion unit in which the first temperature sensor resistor is inserted; and
a TEC insertion unit in which the TEC is inserted.

4. The apparatus according to claim 2 or 3, wherein:
the TOSA is fixed to the TOSA insertion unit centrally formed in a lateral side of the TOSA/TEC fixing unit by epoxy;
the first temperature sensor resistor is fixed to the first temperature sensor resistor insertion unit located at an edge of the lateral side of the TOSA/TEC fixing unit by epoxy; and
the TEC is fixed to the TEC insertion unit included in an upper part of the TOSA/TEC fixing unit by epoxy.

5. The apparatus according to claim 1, wherein the TOSA/heater mounting member includes:
a TOSA for including an uncooled laser diode and a PCB connection terminal connected to a PCB;
a heater mounted to the PCB connection terminal of the TOSA, heating the uncooled laser diode at low temperature, and preventing characteristics of the uncooled laser diode from being changed;
a second temperature sensing resistor acting as a temperature sensor for detecting temperature; and
a TOSA/heater fixing unit for fixing the TOSA including the heater.

6. The apparatus according to claim 5, wherein the TOSA/heater fixing unit includes:
a TOSA insertion unit in which the TOSA is inserted; and
a second temperature sensor resistor insertion unit in which the second temperature sensor resistor is inserted.

7. The apparatus according to claim 5 or 6, wherein:
the heater is fixed to the PCB connection terminal of the TOSA by epoxy;
the TOSA is fixed to the TOSA insertion unit included in both sides of the TOSA/heater fixing unit by epoxy; and
the second temperature sensor resistor is fixed to the second temperature sensor resistor insertion unit located at an edge of the lateral side of the TOSA/TEC fixing unit by epoxy.

8. The apparatus according to claim 2 or 5, wherein the first temperature sensor resistor can be attached to all locations of the TOSA/TEC fixing unit, and the second temperature sensor resistor can be attached to all locations of the heater or the TOSA/heater fixing unit as necessary.
